(19) United States
(12) Patent Application Publication
(10) Pub. No.: US 2014/0049607 A1
(43) Pub. Date: Feb. 20, 2014

(54) Devices and Methods for Sparse Representation of Dense Motion Vector Fields for Compression of Visual Pixel Data

(71) Applicants: Peter Amon, München (DE); Andreas Hutter, München (DE); Professor André Kaup, Effeltrich (DE); Andreas Weinlich, Windsbach (DE)

(72) Inventors: Peter Amon, München (DE); Andreas Hutter, München (DE); Professor André Kaup, Effeltrich (DE); Andreas Weinlich, Windsbach (DE)

(73) Assignee: SIEMENS AKTIENGESELLSCHAFT, München (DE)

(21) Appl. No.: 14/000,227

(22) PCT Filed: Feb. 14, 2012
(86) PCT No.: PCT/EP2012/052480

§ 371 Date: Nov. 4, 2013

(30) Foreign Application Priority Data
Feb. 18, 2011 (EP) 11155011.7
Jul. 7, 2011 (EP) 11173094.1

(51) Int. Cl. H04N 13/00

(52) U.S. Cl. CPC H04N 13/0048
USPC 348/43

(57) ABSTRACT

A coding method for the compression of an image sequence involves firstly determining a dense motion vector field for a current image region of the image sequence by comparison with at least one further image region of the image sequence. Furthermore, a confidence vector field is determined for the current image region. The confidence vector field specifies at least one confidence value for each motion vector of the motion vector field. Based on the motion vector field and the confidence vector field, motion vector field reconstruction parameters are then determined for the current image region. Furthermore, a decoding method decodes image data of an image sequence which were coded by such a coding method.

### CROSS REFERENCE TO RELATED APPLICATIONS

This application is based on and hereby claims priority to International Application No. PCT/EP2012/052480 filed on Feb. 14, 2012 and European Application Nos. 11155011.7 filed on Feb. 18, 2011 and 11173094.1 filed on Jul. 7, 2011, the contents of which are hereby incorporated by reference.

### BACKGROUND

The invention relates to a coding method for compression of an image sequence, and to a decoding method for decoding an image sequence which was coded using such a coding method. The invention further relates to an image coding device and a corresponding image decoding device, and to a system comprising such an image coding device and image decoding device.

An image sequence in the following is understood to be any succession of images, e.g. a series of moving images on a film or a succession of e.g. temporally and/or spatially adjacent layers depicting the interior of an object, as captured by medical technology devices, which can then be navigated virtually for the purpose of observation, for example. Furthermore, an image sequence also comprises temporal correlations in dynamic image data such as e.g. three-dimensional time-dependent mappings or reconstructions of an object (so-called 3D+t reconstructions), e.g. of a beating heart. An image region in this case is understood to be either one or more complete images from this image sequence, or also merely part of such an image. The images can be either two-dimensional images or three-dimensional image data in this case. This means that the individual image points can be either pixels or voxels, wherein the term pixel is used below for the sake of simplicity and (unless explicitly stated otherwise) voxels are also implied thereby.

It is currently normal practice for diagnostic medical images in clinical environments to be stored without compression or at least using lossless compression, in order to satisfy the requirements of doctors and legal conditions. A currently typical standard for storing such medical image data is defined in the DICOM standard. Unlike non-compressed RAW images, the DICOM data record also allows images to be stored without loss in compressed formats such as e.g. TIFF or JPEG 2000 in. However, such compression methods for two-dimensional images were not created for the purpose of compressing e.g. the above cited 3D+t reconstructions, which are captured using imaging devices such as computer tomographs or magnetic resonance tomographs, for example. Consequently, the layers of such volumes are currently stored as individual mutually independent images. This means that if the capabilities of current imaging devices are used to generate high-resolution 3D+t data records, large quantities of image data are produced for each examination.

In fields such as these in particular, but also in other similar fields where large quantities of image data occur, a requirement therefore exists for compression algorithms which make optimal use of the spatial, temporal and probability theoretical redundancies in order to allow rapid and efficient transfer and storage of the image data. In order to achieve the desired entropy reduction, the model-based assumption that only small intensity variations occur between spatially adjacent pixels is often used as a basis. In this context, so-called “predictive coding” attempts to imply the future or current image data on the basis of known data that has been read previously, e.g. preceding images of an image sequence. The so-called “residual error”, i.e. the difference between a prediction of an image and the true image, and sufficient information to recreate the prediction are then stored or transferred for a current image. The advantage is that the deviation from the true values is only very small or close to zero in the case of a good prediction. The fundamental principle here is that values which occur more frequently can be stored using short codewords, and only values that occur more rarely are stored using long codewords. As a result, less storage and/or transfer capacity overall is required for the image data.

Such a predictive coding can make use of motion vectors in order to represent motion of objects in a video sequence or in different layers of a 3D volume. Using a correspondingly high number of motion vectors here, it is actually possible effectively to describe the exact change between the individual “frames” (images in the video sequence or layers). However, the overheads involved in coding the motion information (i.e. the additional information that is required in respect of the motion vectors) can negate all of the efficiency of the compression.

Commonly used video compression algorithms therefore attempt to reduce spatial variations by so-called block-based translational motion predictions, thereby compensating for said spatial variations a temporal direction. In this context, the motion of predefined pixel blocks in the current image is determined relative to the preceding image while minimizing an intensity difference norm. If this motion information is used as a prediction, it is only necessary for the residual error, i.e. the remaining difference, which also contains significantly fewer variations than the original image in this method, to be transmitted or stored again in order to allow lossless reconstruction by a decoder after the transmission or readout from the storage.

It is however problematic that such a static predictive model is not able to compensate for any rotational motion, scaling motion or deformation, or for other non-translational image motion. Not only is it impossible to suppress existing intensity variations at positions where such motion occurs, but additional variations may also occur at the block boundaries. Such simple block-based methods are therefore not particularly suitable for medical image data in particular, since purely translational motion in the images can rarely be expected here, and deformational motion of the tissue caused by muscular contractions such as heartbeat, respiration, etc. is more common.

The compression standard H.264/AVC [“Advanced video coding for generic audiovisual services,” ITU-T Rec. H.264 and ISO/IEC 14496-10 (MPEG-4 AVC), 2010] describes various improvements to the block-based method in order to reduce such problems. One improvement is allowed by an adaptive change of the block size, for example, wherein the selected block size is not uniform, but is varied according to the residual error. In a further method, it is proposed that the original values of the image should be taken if the errors between prediction and current image are too great. In yet another method, a plurality of images are combined in a weighted manner, and the resulting image is used as a reference image for the prediction. According to a further proposal, images featuring significant changes should first be smoothed and the motion vectors then determined from the smoothed image, in order thus to obtain a better prediction. In a further proposal, provision is made for performing a lattice-based motion estimation in which a triangular grid network is used instead of a block matrix and the motion vectors are stored for each trilinear point, wherein vectors in the triangles are interpolated. According to a further proposal relating to affine block deformation, affine transformations of the blocks can be taken into consideration in addition to the translational motion [see Chung-lin Huang and Chao-yuen Hsu, “A new motion compensation method for image sequence coding using hierarchical grid interpolation” in IEEE Transactions on Circuits and Systems for Video Technology, Vol. 4, no. 1, pp. 42-52, February 1994]. However, these methods are hardly used as yet due to their considerable complexity and the increased use of supplementary information and/or their applicability exclusively to specific data forms.

In principle, pixel-based motion vector fields can be used effectively to estimate any motion in which each pixel is assigned a dedicated motion vector. However, supplementary information required for this purpose in relation to the individual motion vectors is so extensive that such methods are generally unsuitable, particularly if high-quality compression is desired. Therefore such information must itself be reduced in a lossy method. In a publication by S. C. Han and C. I. Podilchuk, “Video compression with dense motion fields”, in IEEE Transactions on Image Processing, vol. 10, no. 11, pp. 1605-12, January 2001, this is achieved by using a selection algorithm in which all non-distinctive motion vectors in a hierarchical quadtree are eliminated. The remaining vectors are then coded in an adaptive arithmetic entropy coder. In principle, this involves a similar method to an adaptive block method in accordance with the standard H.264/AVC, though the motion vectors not only of blocks but also of each individual pixel are checked here. This method is therefore relatively time-consuming.

### SUMMARY

One possible object is to provide an improved coding method and an image coding device by which more efficient compression and in particular even lossless compression is possible, in particular even in the case of image sequences that involve complicated motions.

The inventors propose a coding method involving the following. Firstly, provision is made for determining a dense motion vector field for a current image region of the image sequence by comparison with at least one further image region of the image sequence. In the context of this discussion, a “dense motion vector field” is understood to be a motion vector field in which individual pixels or voxels, preferably every pixel or voxel, of the observed image region is assigned a dedicated motion vector or at least a motion vector component, in contrast with block-based motion vector fields, in which blocks are defined in advance and motion vectors are specified for these blocks only. In the following, a “thinned dense” motion vector field is understood to be a dense motion vector field, comprising pixel-based or voxel-based motion vectors or motion vector components, which has already been thinned during the proposed compression, i.e. in which motion vectors have already been eliminated.

As described above, an image region is usually a complete image in the image sequence. However, it can also be just part of such an image in principle. The further image region of the image sequence, which is used for comparison, is then a corresponding image region in a further image, e.g. a preceding and/or succeeding image, wherein it is also possible here to use not just one further image but a plurality of further images which are combined in a weighted manner, for example, or similar.

In a preferred method, the dense motion vector field is determined using a so-called “optical flow method” as opposed to a simple motion estimation. Such optical flow methods are known to a person skilled in the art and therefore require no further explanation here.

In a further step, which can take place concurrently with or after the determination of the motion vector field, provision is made for determining a confidence vector field for the current image region. This confidence vector field specifies at least one confidence value for each motion vector of the motion vector field. The confidence value specifies the probability that the estimated motion vector is actually correct, i.e. how good the estimate is likely to be. It is also possible to determine confidence values that differ vectorially in this case, i.e. the confidence value itself can be a vector or a vector component, wherein the vector components specify the confidence value in each case, i.e. the accuracy of the motion vector of the image in a row direction or column direction (also referred to as x-direction and y-direction respectively in the following). It is noted in this context that although the method is described in the following with reference to two-dimensional images for the sake of simplicity, it can readily be developed into a three-dimensional method by adding a third vector component in a z-direction.

Finally, motion vector field reconstruction parameters are determined for the current image region on the basis of the motion vector field and the confidence vector field.

These motion vector field reconstruction parameters can then be held in storage or transmitted via a transmission channel, for example, and then used again to reconstruct the dense motion vector field, the actual reconstruction method depending on the type of motion vector field reconstruction parameters that are determined. Various possibilities can be used to achieve this, as explained in further detail below.

As a result of using the confidence vector field in addition to the motion vector field when determining the motion vector field reconstruction parameters, it can be ensured in a relatively simple manner that very good reconstruction of the motion vector field is possible using the determined motion vector field reconstruction parameters. Not only can the quantity of the data required for reconstruction of the motion vector field be significantly reduced in this way, but the use of the confidence values even ensures that only the particularly reliable motion vectors are used, thereby improving the quality of the reconstruction in addition to significantly reducing the data.

If the method is used in a context in which the residual-error data is usually stored or transferred in addition to the information for motion vector field reconstruction for an image prediction, in order thereby to store or transfer lossless images, the method results in only relatively little supplementary information in comparison with conventional block-based motion estimation methods. Block-forming artifacts or other rapid variations are avoided within the residual-error coding and high values for the residual errors are efficiently suppressed in this case, further contributing to a particularly effective compression method.

For the purpose of compressing an image sequence using such a method, the inventors propose an image coding device including the following components:
a motion vector field determination unit for determining a dense motion vector field for a current image region of the image sequence by comparison with at least one further image region of the image sequence,
a confidence vector field determination unit for determining a confidence vector field for the current image region, which confidence vector field specifies at least one confidence value for each vector of the motion vector field,
a reconstruction parameter determination unit for determining motion vector field reconstruction parameters for the current image region on the basis of the motion vector field and the confidence vector field.

In order to decode an image sequence that has been coded using the proposed method, a decoding method is required in which a motion vector field is reconstructed for a current image region on the basis of the motion vector field reconstruction parameters, and an image region prediction is determined on the basis of this and the further image region that was used to determine the motion vector field.

Correspondingly, the inventors propose an image decoding device including:
a motion vector field reconstruction unit, in order to reconstruct a motion vector field for a current image region on the basis of the motion vector field reconstruction parameters, and
a prediction image generation unit, in order to determine an image region prediction on the basis of the motion vector field and the further image region that was used to generate the motion vector field.

The coding method and decoding method can be applied in a method for transmitting and/or storing an image sequence, wherein the image regions of the image sequence are coded using the proposed method before the transmission and/or storage, and are decoded using the corresponding decoding method after the transmission and/or after extraction from the storage. Correspondingly, an proposed system for transmitting and/or storing an image sequence features an image coding device and an image decoding device.

In particular, the proposed coding device and the proposed image decoding device can also be implemented in the form of software on suitable image processing computer units having corresponding memory capacity. This applies in particular to the motion vector field determination unit, the confidence vector field determination unit, the reconstruction parameter determination unit, and the motion vector field reconstruction unit and the prediction image generation unit, which can be realized in the form of software modules, for example. However, these units can also be designed as hardware components, e.g. in the form of suitably constructed ASICs. A largely software-based implementation has the advantage that previously used image coding devices and image decoding devices can easily be upgraded by a software update in order to function in the proposed manner. The inventors therefore also propose a computer program product which can be loaded directly into a memory of an image processing computer and comprises program code sections for executing all of the steps in the proposed method, e.g. in an image processing computer for providing an image coding device or in an image processing computer for providing an image decoding device, when the program is executed in the image processing computer.

The teachings relating to the coding method, coding device, decoding method, decoding device and computer readable storage medium can be applied to each other. Individual features or groups of features can likewise be combined to form further exemplary embodiments.

The motion vector field reconstruction parameters that are determined in the proposed coding method could in principle be used thus for simple lossy compression of an image sequence.

In the context of the coding method, provision is preferably made for first reconstructing a motion vector field by the motion vector field reconstruction parameters. An image region prediction for the current image region is then determined on the basis of the motion vectors (exclusively) of the reconstructed motion vector field and on the basis of the further image region that was originally used to determine the motion vector field. Residual error data is then determined, e.g. by finding the difference between the current image region and the image region prediction, and finally the motion vector field reconstruction image parameters are linked to the residual error data of the current image region. The data can then be stored and/or transmitted.

Linking the motion vector field reconstruction parameters to the residual error data can be effected by a direct data association in this case, e.g. in the form of a multiplexing method or a similar suitable method. It is however sufficient in principle if, following the storage or transmission, it is possible in some way to identify which motion vector field reconstruction parameters belong to which residual error data. During the decoding, after extraction of the residual error data and the motion vector field reconstruction parameters from the transmitted and/or stored data, e.g. in the context of a demultiplexing method, a motion vector field can be reconstructed from the motion vector field reconstruction parameters again, and the image region prediction can be determined on the basis of this. The current image region can then be reconstructed exactly by the residual error data.

For this purpose, the image coding device includes a corresponding motion vector field reconstruction unit, such as is also provided e.g. at the image decoding device, and a comparator for determining the residual error data, i.e. the deviations of the current image region from the image region prediction, and a suitable coding unit for coding this residual error data as appropriate and linking it to the motion vector field reconstruction parameters, e.g. by a suitable linking unit such as a multiplexer.

Correspondingly, provision must then be made at the image decoding device firstly for a data separation unit such as a demultiplexer, for separating the motion vector field reconstruction parameters from the residual error data, a unit for decoding the residual error data, and a combination unit for determining the exact current image region from the prediction images and the decoded residual error data, preferably with zero loss.

According to a particularly preferred variant of the method, the motion vector field and/or the confidence vector field are generated and/or processed componentially in the form of vector component fields. This means that in the case of a two-dimensional image, for example, the x-component and y-component of the motion vector field are handled separately and therefore two vector component fields are generated. As mentioned above, it is also possible correspondingly to generate separate confidence vector component fields, which in each case specify the quality of the vector components in one of the two directions. It is clear that expansion into a third dimension in a z-direction is also possible here in principle.

Separate handling of the vector components in different directions has the advantage of being able to allow for the possibility that a vector at a specific image point or pixel can with high probability be specified very accurately in one direction, while it can only be specified inexactly in the other direction. This is exemplified by an image point lying at the edge of an object, which edge runs in an x-direction. Since the contrast difference is very great in the y-direction due to the jump at the edge, a displacement of the image point between two consecutive images can be detected with relatively high accuracy in a y-direction, such that the motion vector in this direction can be specified very accurately. By contrast, a specification of the motion vector component in a longitudinal direction of the edge is inferior because the change is probably modest or even undetectable.

Various possibilities exist for determining the motion vector field reconstruction parameters.

According to a particularly preferred variant, relevant feature points of the motion vector field are determined in the context of the method, and the motion vector field reconstruction parameters then include location information in each case, e.g. location coordinates or other data for identifying a relevant feature point, and at least one component of a motion vector at the relevant feature point concerned. This means that the position of the pixel and at least one associated motion vector component are determined for each relevant feature point.

In order to determine the relevant feature points in this case, provision is preferably made for first specifying a group of candidate feature points on the basis of the confidence vector field, each candidate feature point again comprising the location information of the pixel concerned and at least one associated motion vector component. This can be achieved by specifying local maxima of the confidence vector field, for example. Relevant feature points can then be selected from these candidate feature points. For this purpose, a suitable coding device includes e.g. a candidate feature point determination unit, such as e.g. a maxima detection facility which searches through a confidence vector field for these local maxima, and a feature selection unit.

According to a particularly preferred development of the method, for the purpose of selecting the relevant feature points from the candidate feature points, it is possible, for individual candidate feature points and preferably for each of the candidate feature points, to generate a dense motion vector field and/or an image region prediction for the current image region in each case, without a motion vector component belonging to this candidate feature point. The effect on the motion vector field and/or the image region prediction can then be checked. In other words, the relevant feature points are selected from the candidate feature points by determining the effect of these candidate feature points being present or not.

In this case, it is possible for example to check whether the deviations between the image region prediction with and without this motion vector lie below a predefined threshold value. If so, the candidate feature point is not a relevant feature point. According to a further alternative, the deviations between the image region predictions with and without the relevant motion vector are registered in each case. This test is performed for each of the candidate feature points and the results are likewise stored in a field or vector field, for example. The n feature points having the fewest deviations are then the relevant feature points, where n is a predefined number. This method likewise allows a componential separation of operations.

This first method is therefore based on the idea that a thinned dense vector field is generated from the dense vector field using the confidence values of the confidence vector field, wherein said thinned dense vector field now contains only the vectors or vector components for the feature points or pixels that are actually relevant.

For the purpose of reconstructing the dense motion vector field, these candidate feature points or their motion vector components are preferably then used as “nodes” for the purpose of interpolating or extrapolating the other motion vectors of the dense motion vector field in a non-linear method, for example. This means that the dense motion vector field is determined by “fitting” areas to these nodes using suitable base functions. For this purpose, the motion vector field reconstruction unit preferably has a unit for non-linear interpolation and/or extrapolation of the motion vectors based on the motion vector components of the candidate feature points.

According to an alternative second method, coefficients are determined as motion vector field reconstruction parameters on the basis of the motion vector field and the confidence vector field, in order to reconstruct the motion vector field using predefined base functions. These coefficients can preferably be determined in a linear regression method. It is then easy to reconstruct the motion vector field on the basis of the coefficients by a linear combination of the predefined base functions.

In a preferred variant, the base functions can be predefined in this case. For this purpose, the base functions must be known in advance to both the image coding device and the image decoding device. However, it is then sufficient to simply specify the coefficients and to transfer only these as supplementary information in addition to the residual error data, for example.

According to an alternative variant of this second method, base functions belonging to the coefficients and used for the reconstruction of the motion vector field are also determined on the basis of the motion vector field and the confidence vector field. These base functions can be selected from a group of predefined base functions, for example. Using this method, it is therefore not necessary for the image decoding device to be informed of the base functions in advance. Instead, the determined base functions or information for identifying the base functions is transferred or stored with the coefficients and possibly the residual error data.

In all of the above cited methods, the confidence vector field can preferably be determined by determining a deviation area for each position, i.e. for each point or pixel of the motion vector field. This deviation area contains the possible deviations of a prediction image point, which is based on the motion vector at the current position, from an image point at the relevant position in the current image region as a result of a change in the motion vector by a defined variation around the currently observed image point, e.g. in a space of 3×3 pixels. A curvature value of this deviation area can then be determined in at least one direction in each case as a confidence value, i.e. the second derivation is determined e.g. componentially for each point, such that the confidence vector field is structured componentially accordingly.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an image sequence comprising four temporally consecutive recordings of a layer in a dynamic cardiological computer tomograph-based image data record,

FIG. 2 shows a flow diagram of a first exemplary embodiment of a proposed coding method,

FIG. 3 shows a representation of the x-component of a reconstructed motion vector field,

FIG. 4 shows a representation of the y-component of a reconstructed motion vector field,

FIG. 5 shows a block schematic diagram of a first exemplary embodiment of a proposed image coding device,

FIG. 6 shows a flow diagram of a first exemplary embodiment of a proposed decoding method,

FIG. 7 shows a block schematic diagram of a first exemplary embodiment of a proposed image decoding device,

FIG. 8 shows a representation of the mean residual error data quantity and the total information quantity per frame as a function of the motion information quantity,

FIG. 9 shows a representation of the mean squared error (MSE) per frame as a function of the motion information quantity,

FIG. 10 shows a representation of the third image from FIG. 1 with a partially shown superimposed dense motion vector field,

FIG. 11 shows a representation of the confidence values in an x-direction of the image from FIG. 10,

FIG. 12 shows a representation of the third image from FIG. 1 with a thinned motion vector component field as per FIG. 10,

FIG. 13 shows a representation of the third image from FIG. 1 with the superimposed motion vector field, which was reconstructed on the basis of the motion vectors as per FIG. 12,

FIG. 14 shows a representation of the quadruplicate residual error in the first coding method,

FIG. 15 shows a representation of the quadruplicate residual error in a block-based predictive coding method,

FIG. 16 shows a flow diagram of a second exemplary embodiment of the proposed coding method,

FIG. 17 shows a flow diagram of a third exemplary embodiment (here a variant of the second exemplary embodiment) of the proposed coding method,

FIG. 18 shows a block schematic diagram of a second exemplary embodiment of the proposed image coding device,

FIG. 19 shows a flow diagram of a second exemplary embodiment of the proposed decoding method,

FIG. 20 shows a block schematic diagram of a second exemplary embodiment of the proposed image decoding device.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

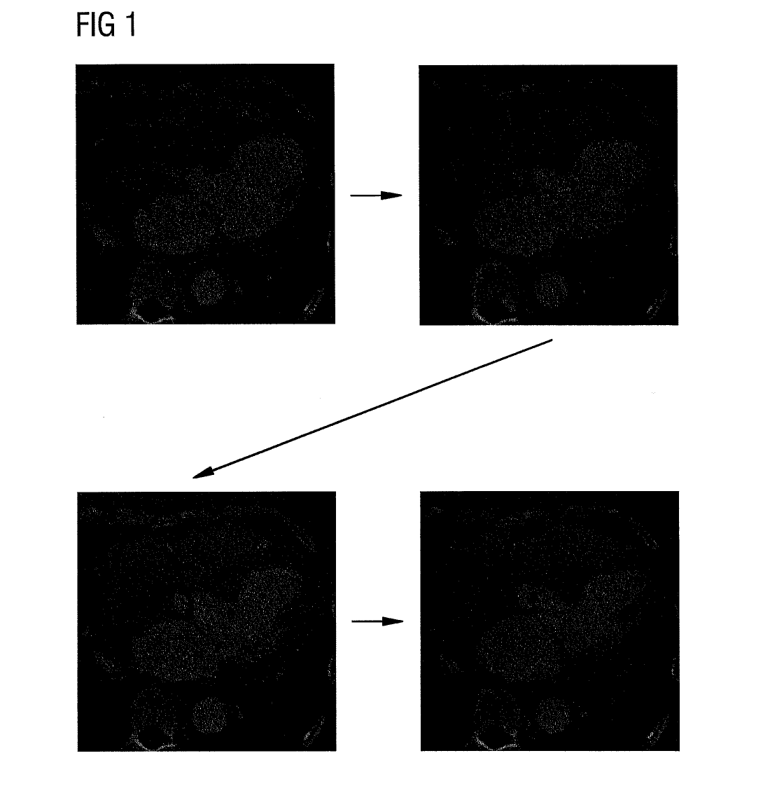

FIG. 1 shows four images of an image sequence including four consecutive recordings of one and the same layer, which were captured in the context of a dynamic cardiological image data record. In contrast with conventional video recordings, for example, these images show that the various objects primarily undergo a deformational motion over time. It is assumed in the following that the proposed method is primarily used for the compression of such medical image data, though the method is not restricted to such a use. For the sake of simplicity, it is further assumed in the following that complete images of an image sequence are coded or decoded in each case, though it is also possible to code and decode only specific image regions of an image, as described above.

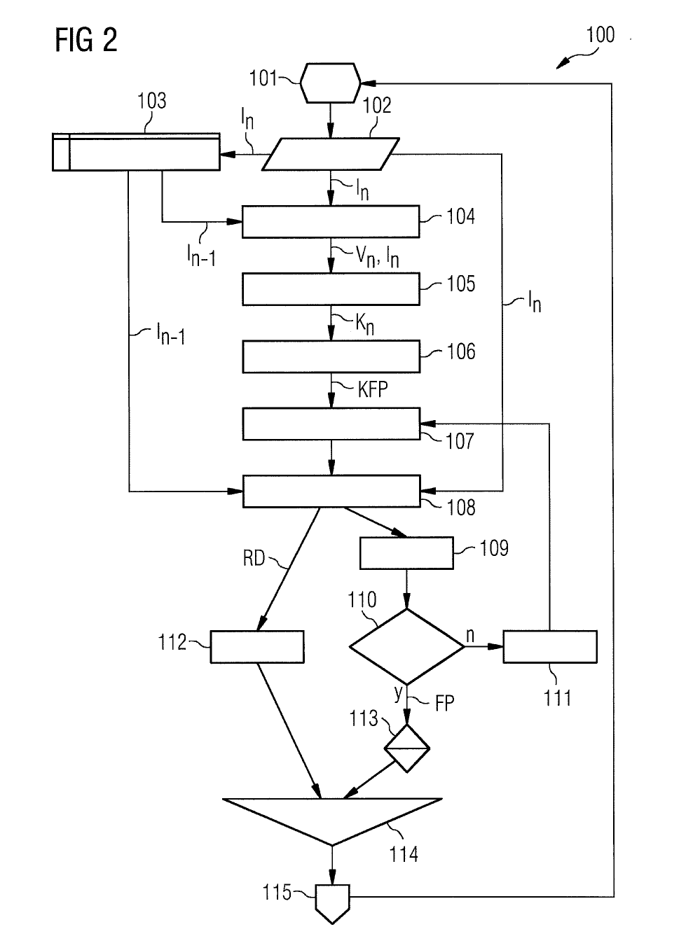

A first variant of a lossless coding method 100 is now described with reference to FIG. 2. In this case, the description relates to a coding run for an image in the image sequence, for which a previous image was already stored. Therefore this method cannot be applied to the first image of an image sequence, since there is then no comparison image that can be used as a basis for generating a prediction image or a motion vector field.

The method for coding an image begins in the step 101 (as a starting point), wherein a step 102 first provides for reading in a RAW image Iₙ. This is then stored in a step 103 for the next iteration, i.e. the processing of the Iₙ₊₁ image. The image Iₙ is also used in a step 104, in conjunction with a preceding image Iₙ₋₁ which was placed in the storage in the step 103 during the preceding coding run, to determine a dense motion vector field Vₙ.

The use of such a dense motion vector field Vₙ has the advantage in particular of allowing better adaptations to any tissue motion and hence better predictions. Moreover, the assumption of a “smooth” motion has further advantages, e.g. in that methods based thereon are not restricted to block-based compression methods and can be combined with spatial prediction methods such as JPEG-LS or wavelet compression methods in a spatial and temporal direction with regard to the coding of the residual error data.

A correlation-based optical flow method, such as that which is similarly described in e.g. P. Anandan, “A Computational Framework and an Algorithm for the Measurement of Visual Motion”, Int. Journal of Computer Vision, 2(3), pp. 283-310, January 1989, can be used to estimate or obtain the dense motion vector field. The algorithm used therein is intended to minimize a weighted linear combination of the sum of the squared intensity differences (SSD) of a neighborhood around a moving image point and the differences of adjacent motion vectors. For this purpose, the image size of both the current and the preceding image is scaled down multiple times by a factor of two in each dimension (i.e. in x-direction and y-direction and hence by a factor of four overall) until a size is reached in which the motion can determine a maximum of one pixel. After the motion has been estimated, the vector field is then scaled up hierarchically by a factor of two in each case with regard to both the resolution and the vector length, using a preferably bilinear interpolation method, until the original image size of the original images is finally reached again. In this way, the estimation is improved at each stage by an iterative algorithm in which a 5×5 pixel neighborhood at each position x in the current image Iₙ is compared with nine candidate positions (candidate motion vectors) v in the previous image Iₙ₋₁. In this case, the candidate positions v lie within a search region of just one pixel, i.e. in an 8-pixel neighborhood around the position which is indicated by the preceding vector estimate vₙ₋₁. This can be described by the following equation:

$${v}_{t} ( x ) = {arg min}_{v ∈ {N}_{3 \times 3} ( {v}_{t - 1} ( x ) )} ( {\sum }_{r ∈ {N}_{5 \times 5} ( x )} {( {I}_{n} ( r ) - {I}_{n - 1} ( r + v ) )}^{2} + λ \vert v - \frac{1}{8} {\sum }_{l ∈ {N}_{3 \times 3} ( x ) - \{ x \}} {v}_{t - 1} ( 1 ) \vert ) \qquad ( 1 )$$

In this equation, the first sum term minimizes the intensity differences and the second term with the sum variable I (in which the sum runs over all I in a 3×3 environment around the point x with the exception of the point x itself) minimizes the differences between the respective candidate positions v and the eight neighbors. In equation (1), t is the iteration index. In equation (1) as elsewhere in the following, it is assumed that the displacement vector (i.e. the motion vector) v is stored in such a format as to specify the place in the preceding image from which a pixel in the current image was displaced. Correspondingly, r in equation (1) represents a position which is situated in the 5×5 field around a position x and contributes to the comparison of the intensity values, and v is one of the nine search positions in the previous image in the context of a pixel displacement in all directions. The weighting parameter λ is heuristically selected and depends on the format in which the intensities are stored. If an intensity between 0 and 1 is stored, for example, a weighting parameter λ of e.g. 10⁻³ can be selected. The first term and the second term of the equation (1) must be of the same magnitude to a certain extent.

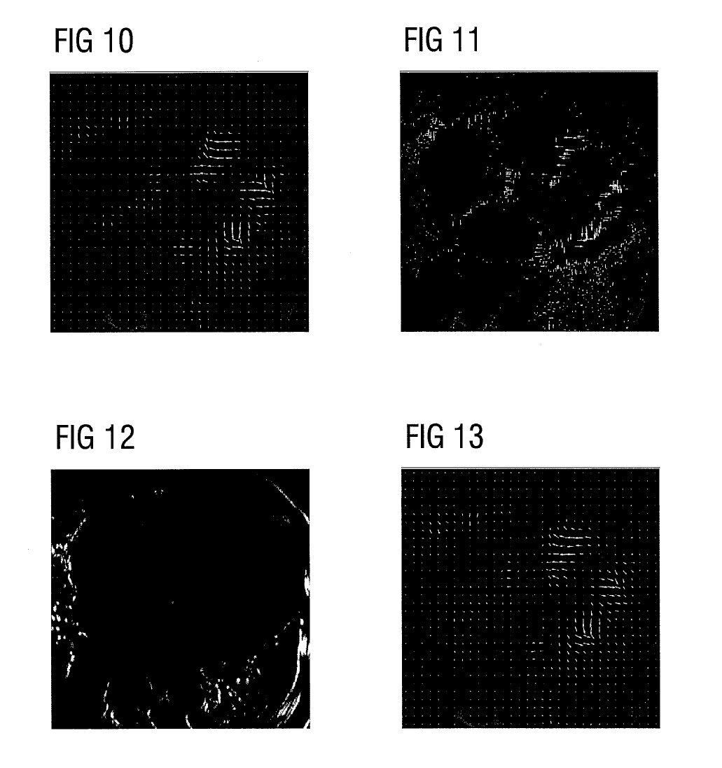

It is usually sufficient to perform approximately 2 to 10 iterations in each stage in order to obtain a very good approximation of the motion. In an existing test exemplary embodiment of the method, a 512×512 pixel/voxel vector field with ten iterations per stage was already produced in less than two seconds on a conventional 2.8-GHz CPU using a simple C program. Significantly higher speeds can be achieved using a module (e.g. an ASIC) which is designed specially for this purpose. FIG. 10 shows a motion vector field which has been calculated using this method for the third image of the sequence from FIG. 1. However, a downsampling of the original dense motion vector field was applied when producing the image in order to allow a better representation in the figure.

It is explicitly noted that another suitable method can also be used instead of the method specifically described above for determining a dense motion vector field in the context of this discussion. In order to achieve further improvements of the method in the case of relatively noisy image data, the high-frequency variations between the pixels that may occur in the context of pixel-based motion estimation can be reduced by additional inloop noise reduction filter methods, e.g. using a small Gaussian kernel or edge-preserving methods.

On the basis of the motion vector field Vₙ and the current image Iₙ, a confidence vector field Kₙ for the current image Iₙ is then determined in the step 105 according to FIG. 2. This confidence vector field Kₙ describes the reliability in the prediction of the temporal motion of the individual pixel data on the basis of the dense motion vector field Vₙ.

One possible way of specifying confidence values for each of the motion vectors is described in the following, wherein this again merely represents a preferred variant and other methods can also be used to determine confidence values.

This method is based on a somewhat modified variant of a method described in the above cited publication of P. Anandan. In the context of the method described above, the SSD values in a 3×3 search environment around the estimated optimal displacement vector are again determined at the highest resolution level in each case, in the same way as a further iteration for improved motion estimation when determining the motion vector field. This means that a separate SSD surface of 3×3 pixels in size is determined for each vector. It is then possible to calculate two confidence values in x and y on the basis of the curvature of these SSD surfaces. For this purpose, it is possible simply to calculate the second derivation of these surface functions, wherein this can be represented in the form of a matrix as follows:

$${k}_{x} = {w}^{T} Sd \\ {k}_{y} = {d}^{T} Sw , \\ where \\ d = [ \begin{matrix}1 \\ - 2 \\ 1\end{matrix} ] , \\ w = [ \begin{matrix}1 \\ 2 \\ 1\end{matrix} ] \qquad ( 2 )$$

In this context, S is the 3×3 SSD matrix and kₓ, k_{y} are the confidence values in x-direction and y-direction. If a pixel in a homogeneous image region is observed, for example, all of the entries in the matrix S are similar. In this case, the confidence values kₓ, k_{y} of the two estimated vector components are only low. If the pixel is located at a vertical intensity limit (running in an in y-direction), the SSD value increases when the search position is changed in an x-direction. The matrix S therefore has a higher value in its left-hand and right-hand columns, such that the confidence value kₓ is high in an x-direction. Similarly, a higher confidence value k_{y} in a y-direction would occur if the pixel were located at a horizontal intensity limit running in an x-direction. FIG. 11 shows an example for the confidence values kₓ in an x-direction of the motion vectors from FIG. 10. The bright regions show a high reliability of the motion vectors since vertical edges are present here.

Since the motion vectors as a whole or at least one of the components of the motion vector is relatively unreliable in many regions, these vectors should not be used for a good prediction in principle. It is therefore sufficient for only the reliable motion vector components to be used in the context of subsequent processing, i.e. for the compression of the data, and for only these to be transmitted or stored. The other motion vectors can then be extrapolated or interpolated again as part of a reconstruction of the dense motion vector field, this being possible without significant residual error in the case of medical images in particular, due to the contiguous nature of the tissue.

According to the first proposed method, feature points which are actually relevant for the motion, i.e. at which the motion vector can be determined with a high degree of reliability, are therefore determined on the basis of the confidence vector field or the vector component fields for the x-direction and y-direction in each case. This effectively generates a thinned dense motion vector field, on the basis of which a complete dense motion vector field can be reconstructed again. For this purpose, motion vector components are only stored at the important positions (so-called relevant feature points).

Since the confidence values for the two components of a motion vector can be completely different as explained above, it is preferable for the determination of the feature points likewise to take place componentially, i.e. for each vector component separately. A feature point FP is therefore treated as a triple FP=(m,n,k) in the following, where (m,n) represents the position of one such relevant motion vector, i.e. of the feature point FP, and k represents the confidence value of the important component of the motion vector.

In order to find the relevant feature points, candidate feature points KFP are determined first in a step 106 on the basis of the confidence vector field (see FIG. 2 again).

For example, this can be achieved by determining the local maxima in a confidence vector field or preferably in a confidence vector component field (as illustrated for the x-component in FIG. 11, for example). Any extreme value search method can be used for this purpose.

In this case, a position value can be considered to be a local maximum if it has the highest confidence value within a local environment. The size of this environment specifies the minimal distance of the local maxima relative to each other, and therefore also predefines the approximate total number of the initially selected candidate feature points. When selecting this size, the complexity of any subsequent further selection of relevant features from the candidate feature points must be balanced against a possible loss of actually important vector information. Experimental trials showed that a neighborhood between 3×3 pixels and 5×5 pixels is very suitable. In order to reduce the detection of unsuitable maxima in noisy regions, it is also possible to accept as candidate feature points only those maxima having a size which exceeds a specified threshold value. The exact value of such a threshold value depends on the intensity region of the image noise that is currently present. A value of 5% to 10% of the maximal confidence value usually gives good results.

Moreover, even for regions with a high density of maxima or with a high density of motion vectors having a high degree of reliability and similar motion information, it is still possible to obtain a shared representative vector for a group of motion vectors. For this purpose, e.g. the individual components of the motion vectors can be averaged and an average motion vector taken at the position in the center. Correspondingly, such averaging of adjacent groups of motion vector components is also possible if use is made of separate vector component fields for the x-direction and y-direction as described above.

A plurality of relevant feature points FP are then selected from these candidate feature points KFP. This feature point readout process takes place iteratively over a plurality of steps 107, 108, 109, 110, 111 according to the method as per FIG. 2. In this case, the readout of the relevant feature points FP from the candidate feature points KFP takes place here on the basis of a residual error that is produced by these feature points or their motion vector components.

For this purpose, a non-linear motion vector field reconstruction is performed first in the step 107 on the basis of the candidate feature points KFP. The motion vector components at the candidate feature points are used as nodes in this case, in order to provide a suitable area by which the motion vector components at the remaining positions can then be extrapolated or interpolated.

In order to obtain the closest possible approximation to the original motion vector field on the basis of this thinned motion vector field, a plurality of additional requirements should preferably be taken into consideration. Firstly, the relevant motion vector component itself should be reproduced exactly at the relevant feature points, since this vector component has a high confidence value. Furthermore, it should be taken into consideration that motion vectors in the vicinity of relevant feature positions should have similar vector components due to the interconnected tissue, whereas the influence of more distant motion information should preferably be very small.

Vectors that are far from relevant feature points should be short, since the tissue cushions local motion and therefore a global motion is not normally present. It can preferably also be taken into consideration that long evaluation vectors at relevant feature points influence larger environments than shorter vectors, again due to the interconnected nature of the tissue.

If both vector components are handled independently, these criteria can all be realized relatively effectively by a weighted non-linear superposition of 2D Gaussian functions for the extrapolation or interpolation of the motion vector components. Gaussian bell-shaped base functions are preferably positioned over each node (i.e. each relevant vector component) in this context, thereby weighting them such that the maximal weight is present at the actual node and a weight of zero is present at remote nodes. In this way, it is easy to ensure that the original value is preserved at all nodes. This reconstruction of the vector field V=(vₓ(m,n),v_{y}(m,n)) for the x-component (a similar equation applies for the y-component but is not shown) can be represented mathematically by the equation:

$${v}_{x} ( m , n ) = {( {\sum }_{f = 1}^{{F}_{x}} {d}_{f}^{- 4} )}^{- 1} \cdot {\sum }_{f = 1}^{{F}_{x}} \frac{{c}_{f , x}}{{d}_{f}^{4}} exp ( - \frac{{d}_{f}^{2}}{{( σ {c}_{f , x} )}^{2}} ) \qquad ( 3 )$$

In this case, d_{f}²=(m−m_{f,x})²+(n−n_{f,x})² is the square distance from the respective node f, c_{f,x} is the width of the Gaussian function and vₓ(m,n) is the motion vector component in an x-direction at the location (m,n). Gaussian functions are particularly suitable for this task, because they assume high values close to their maximum but drop off very quickly and smoothly outwards. For each of the Fₓ relevant feature points, a Gaussian function can therefore be added with its maximum at the respective feature position (m_{f,x}, n_{f,x}), wherein the width is proportional and the height equal to the vector component c_{f,x}. In order to preserve the criteria of an exact interpolation at a center of each Gaussian function, and to reduce the influence of remote vectors when the feature points are somewhat closer together, a d⁻⁴ weighting function (with the above cited distance d) is also used in each Gaussian function. Finally, the vector components are normalized to the sum of all weighting functions at the vector position. It should be noted that the parameter σ can be selected according to the consistency of the tissue, even when it can be selected in a large (including infinite) region, without this having a significant influence on the reconstruction result.

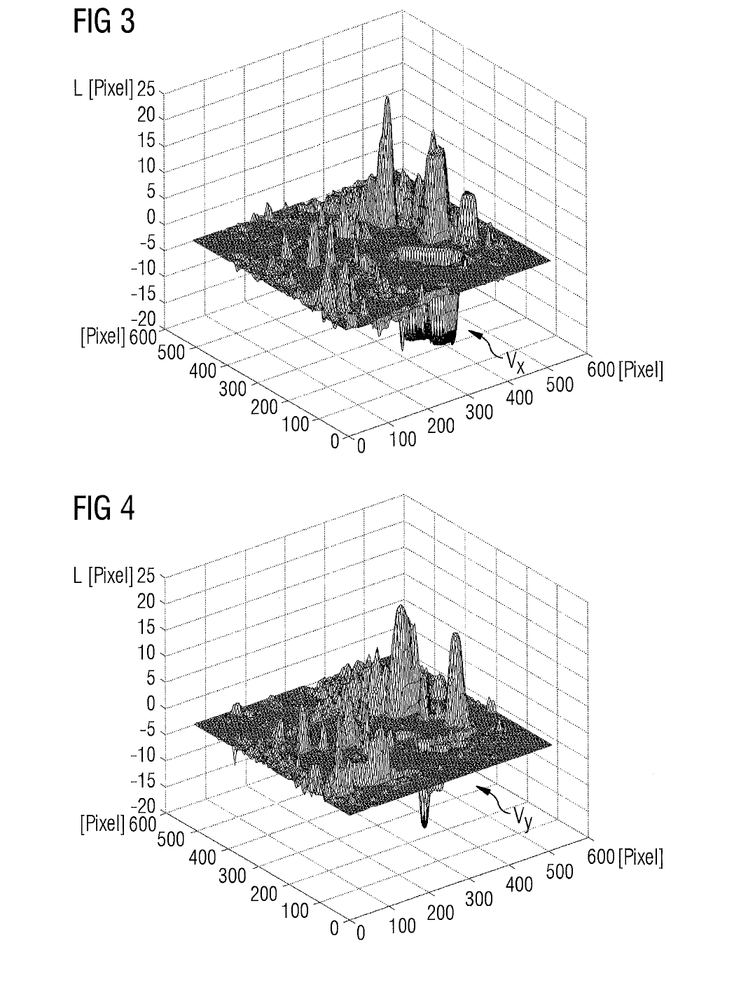

Examples of motion vector component fields Vₓ for the x-component and V_{y} for the y-component of a motion vector field are illustrated in FIGS. 3 and 4. Covering the base area of 512×512 pixels in an x-direction and a y-direction for an image, the length L of the motion vectors (also in pixels) is shown in each case in an x-direction (FIG. 3) and a y-direction (FIG. 4). Corresponding to the actual motion, this results in vector components running in a positive direction and vector components running in a negative direction.

In particular, different base functions can also be selected for reconstruction if medical image data or other images in which deformations primarily occur are not involved. For example, if segmentation of motion in a preceding image of a camera recording is possible, e.g. in the case of a foreground moving object against a background, the base functions can be selected such that they extrapolate only the feature point vector components in the moving region. If base functions having a constant value other than zero are only used within a square region and a suitable motion vector field estimate is used, this method is then similar to a block-based compensation model but with optimization of the block positions.

Using the dense motion vector field that was reconstructed in step 107, a prediction image for the current image is then generated on the basis of the previous image Iₙ₋₁ and subtracted from the current image Iₙ in a step 108. The mean squared error is then calculated in the step 109, and in the step 110 provision is made for checking whether said mean squared error MSE is greater than a maximal permitted error MSE_{Max}.

If this is not the case (branch “n”), a candidate feature point is omitted in the step 111. The selection of which candidate feature point to omit first is made according to the effects on the MSE of the omission of this candidate feature point. Therefore in this step 111 (in a loop which is not shown), for each of the candidate feature points, a dense motion vector field is reconstructed again without the candidate feature point concerned in the context of a non-linear reconstruction method (as in step 107), then a further prediction image is generated and the difference relative to the current image is generated and the mean square deviation MSE for this is determined. The “least important” candidate feature point is then omitted. Using the remaining candidate feature points, a dense motion vector field is reconstructed in the step 107, a further prediction image is generated in the step 108, and the difference relative to the current image is generated and the mean square deviation MSE for this is determined in the step 109. Finally, the step 110 checks whether the mean squared error MSE still does not exceed the maximal permitted error MSE_{Max} and, if so, a new “least important” candidate feature point is sought in a further execution of the loop in step 111.

If the mean squared error MSE is higher for the first time than the maximal permitted error MSE_{Max} (branch “y” in step 110), however, the selection is terminated as no more “omissible” candidate feature points exist. The remaining candidate feature points are then the relevant feature points FP.

Clearly, this termination criterion actually results in the use of a plurality of relevant feature points at which the maximal permitted error MSE_{Max} is just exceeded. However, since a freely definable threshold value is used here, this can already be taken into consideration when the threshold value is specified.

In the case of an optimal readout, it should be noted that every possible combination of feature points must be checked for a desired number of n feature points, i.e. there are

$$( \begin{matrix}N \\ n\end{matrix} )$$

such checks, where N is the number of candidate feature points. In order to reduce the complexity, however, a readout strategy can be selected in which an independent check for every feature point determines how the MSE changes when this feature point is removed. In this way, the number of feature points can gradually be reduced until a desired number of feature points or a maximal MSE is finally reached. Using this method, the number of checks can be reduced to 0.5·N·(n+1). Following selection of the feature points, for each feature position, the position and the relevant components kₓ or k_{y} of the motion vector at this position are transferred or stored as described above, while the other vector components (including those of a relevant feature point) can be estimated in each case from other more reliable positions. By way of example, FIG. 12 shows a set of 1170 feature points which were determined from the dense motion vector field according to FIG. 10.

For the purpose of possible lossless image data compression, the reconstructed vector field can be used to determine a prediction of the current image, i.e. the prediction image. In this case, each pixel is predicted from the corresponding intensity value of the preceding image with reference to the motion vector. After subtraction of the prediction image from the real image data, only the residual error data RD need then be transferred. In order to reduce potential problems in the prediction and hence in the residual errors due to high-frequency noise, particularly in regions featuring high contrast and assuming a preferred accuracy of motion compensation for each individual pixel, provision can be made for simple oversampling of the motion vector field by a factor of two. FIG. 13 shows a motion vector field reconstruction using a prediction that has been compensated accordingly. Comparison with FIG. 10 shows that this corresponds closely to the original actual motion vector field.

In order to determine the residual error data for transmission, the current prediction image is generated and subtracted from the current image once more in a final execution using the feature points that are actually relevant. The residual error data RD obtained in this way is then coded as usual in an intra-coding method 112 (i.e. independently of other images). In this context, all known image or intra-image compression algorithms such as wavelet coding methods (JPEG 2000) or context-adaptive arithmetic coding methods such as JPEG-LS or H.264/AVC can be used in both lossy and lossless methods, depending on their suitability for the respective application. In regions where the residual error is below a specified threshold, it is even possible to dispense with the transfer or storage of the residual error completely. In principle, the motion information (i.e. motion vector field reconstruction parameters) can also be used without explicitly transferring the residual error, e.g. when using motion-compensated temporal filtering methods.

If lossless compression of the data is desired, the selection procedure for the relevant feature positions can also be continued until the combined information quantity of motion vector information and residual error information (in the case of a predefined residual error coding method) reaches a minimum. According to a further possibility for optimization, provision is additionally made for adjacent positions and similar vector components of the feature points (in a similar manner to the feature point selection method) to be checked in respect of their effect on the prediction if the first selection of candidate feature points is not quite optimal. If a better prediction can be achieved in this way, either the position of the feature point or the vector component can be modified.

The relevant feature points and the associated position data and vector components can be coded in an entropy coding method and combined with the intra-coded residual error data in a multiplexing method, this taking place in the step 114. The data for the current image is then sent in the step 115, and the coding of a new image in the image sequence starts in the step 101.

The relevant feature points can optionally still be sorted in a step 113 before the entropy coding. However, the order in which the feature points are transmitted or stored is not particularly relevant in principle. Any algorithm can therefore be used, from a simple “run level” coding to the calculation of an optimal route using a “travelling salesman” algorithm, for example. Such optimized sorting can have the advantage that, using a differential entropy coding method of the positions and motion vector components, the spatial correlation can be minimized for both and therefore the redundancies can be reduced even further.

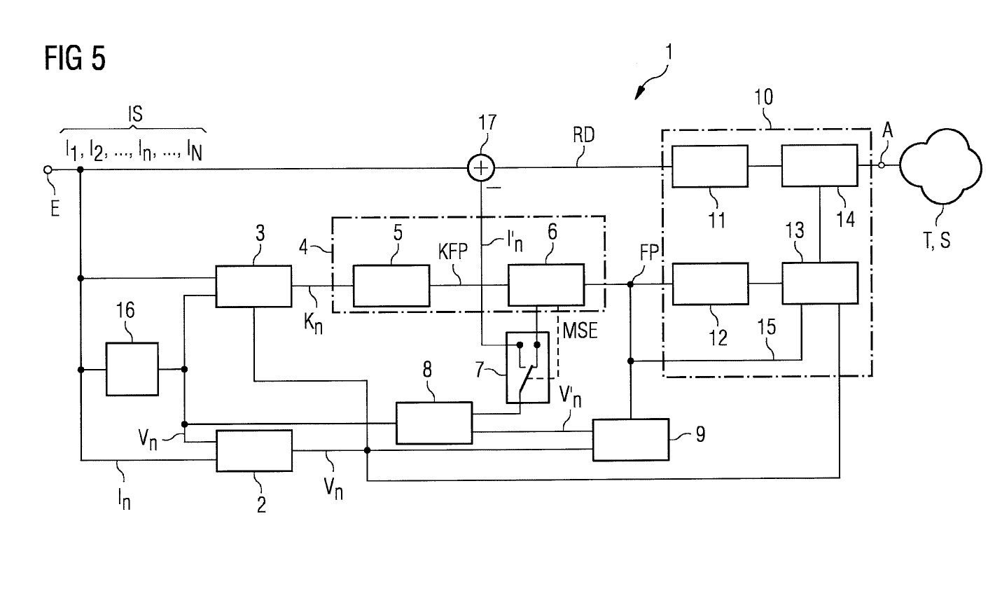

FIG. 5 shows a rudimentary schematic block diagram of a possible structure of a coding device 1 for performing a coding method as described with reference to FIG. 2.

The image data, i.e. an image sequence IS comprising a multiplicity of images I₁, I₂, . . . , Iₙ, . . . , I_{N}, is received at an input E here. The individual images are then supplied to a buffer storage 16 in which the current image is stored for the subsequent coding of the next image in each case, and to a motion vector field determination unit 2 in which a dense motion vector field Vₙ is determined by the optical flow method described above, for example.

At the same time, a current confidence vector field Kₙ (or two confidence vector component fields for the x-direction and y-direction) is determined in a confidence vector field determination unit 3 on the basis of the dense motion vector field Vₙ as determined by the motion vector field determination unit 2 and on the basis of the current image Iₙ and the preceding image which is taken from the storage 16.

This data is forwarded to a reconstruction parameter determination unit 4 including a maximum detection unit 5 and a feature point selection unit 6 here. The maximum detection unit 5 first determines the candidate feature points KFP as described above, and the feature point selection unit 6 then determines the actually relevant feature points FP from the candidate feature points KFP. For this purpose, the feature point selection unit 6 works in conjunction with a motion vector field reconstruction unit 9, which reconstructs a motion vector field V′ₙ on the basis of the current relevant feature points as per step 107 of the method according to FIG. 2, and supplies this to a prediction image generation unit 8 that executes the step according to 108 and determines a current prediction image I′ₙ. Noise in the prediction image I′ₙ can also be eliminated in this prediction image generation unit 8.

This prediction image I′ₙ is then returned to the feature point selection unit 6, which decides on the basis of the mean squared error MSE whether further candidate feature points KFP should be removed or whether all relevant feature points FP have been found. This symbolized here by a switch 7. If the appropriate relevant feature points FP have been found, the current prediction image is subtracted from the current image Iₙ in a subtraction unit 17 (e.g. including a summer with inverted input for the prediction image) and provision is made in a coding unit 10 for linking and coding both the residual errors (or residual error data RD) and the relevant feature points FP.

In principle, the structure of this coding unit 10 is arbitrary. In the present exemplary embodiment, it includes an entropy coding unit 13 by which the motion vector data of the relevant feature points FP (i.e. their positions and relevant vector components) is coded, an intra-coder 11 that codes the residual error data RD, and a subsequent multiplexer unit 14 which links the coded residual error data RD and the coded motion vector data of the feature points together, such that the resulting data can then be output at an output A. From there, this data is either transmitted via a transmission channel T or stored in a storage S.

In the approach described above, the relevant feature points FP for the entropy coding are output directly to the entropy coding unit 13 (via the connection 15 in FIG. 5). Alternatively, an intermediate step can also be performed in a positioning unit 12, which sorts the relevant feature points FP as appropriate, thereby allowing them to be coded even more efficiently by the subsequent entropy coding method in the entropy coding unit 13.

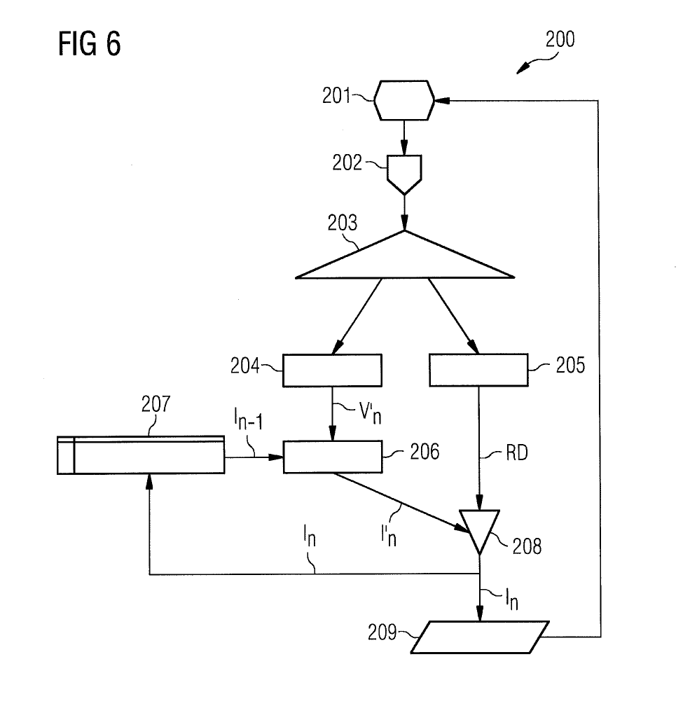

FIG. 6 shows a suitable decoding method 200 by which the image data that was coded as per FIG. 2 can be decoded again. For this method 200 likewise, only one execution for decoding an image of an image sequence is shown, wherein said image is not the first image of image sequence. The execution starts in the step 201, wherein the coded image data is first received or read out from storage in the step 202. The step 203 performs a separation, e.g. demultiplexing of the intra-coded residual error data and the motion vector data of the relevant feature points, and decoding of the motion vector data.

In the step 204, a dense motion vector field V′ₙ is reconstructed on the basis of the decoded motion vector data, exactly as in the step 107 of the coding method 100 according to FIG. 2. At the same time, intra-decoding of the residual error data RD is performed in the step 205. In the step 206, a prediction image I′ₙ is generated on the basis of a previous image Iₙ₋₁, which was stored in the step 207 of the preceding execution, and the motion vector field V′ₙ that was generated in the step 204, said prediction image I′ₙ then being combined in the step 208 with the decoded residual error data RD in order thus to arrive at the current image Iₙ, which is then used further in the step 209. Finally, the method is restarted in the step 201 in order to decode a next image Iₙ₊₁. In the step 207, the generated image Iₙ is also stored for the next execution.

Corresponding to the coding method 100, the decoding in the decoding method 200 according to FIG. 6 also takes place in a componentially separate manner. In other words, separate motion vector fields V′ₙ (or motion vector component fields) are reconstructed for the x-direction and y-direction. For the sake of clarity, this is however not shown in the figures.

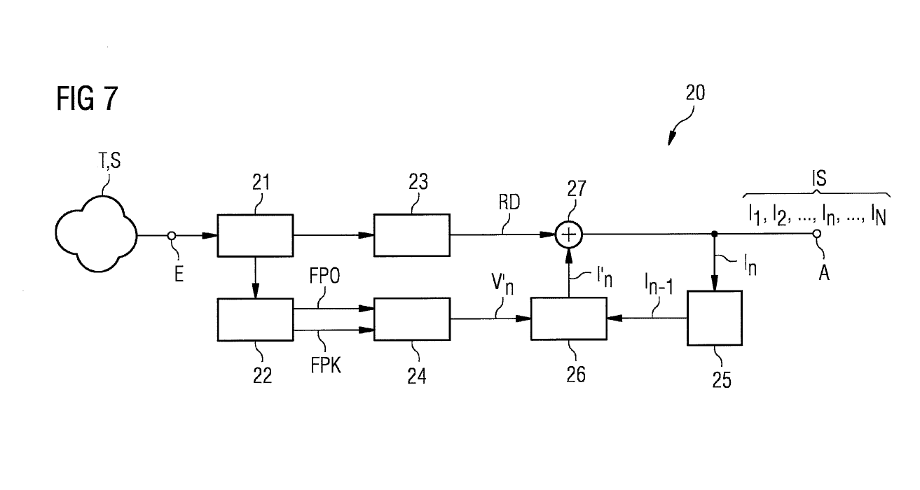

FIG. 7 shows a rudimentary schematic block diagram of a suitable decoding device 20. After the coded data is received at the input E from a transmission channel T or storage S, it is first supplied to a separation unit 21, e.g. a demultiplexer. The coded residual error data is supplied to an intra-decoder 23, which decodes the residual error data RD. The coded motion vector data of the relevant feature points is supplied to a decoding unit 22, e.g. an entropy decoder and in particular an arithmetic decoder, which decodes the motion vector data and supplies the positions, i.e. location information FPO relating to the relevant feature points and the motion vector component FPK of the relevant feature points FP, to the motion vector field reconstruction unit 24. In principle, this is constructed in the same way as the motion vector field reconstruction unit 9 of the image coding device 1. The dense motion vector field V′ₙ that is reconstructed in this case is then supplied to a prediction image generation unit 26, which is likewise constructed in the same way as the prediction image generation unit 8 of the image coding device 1. Noise suppression can be performed here likewise. The prediction image is then combined with the residual error data RD in a summer 27, in order that the decoded image sequence IS can then be output again at output A. The currently decoded image Iₙ is first stored in a buffer storage 25, so that it can be used by the prediction image generation unit 26 in the next execution.

One main advantage of the method as opposed to block-based methods relates to the smooth motion vector field and the associated avoidance of block artifacts. As a result, the subsequent use of spatial redundancies is not limited to pixels within a block and better residual error coding methods can be applied.

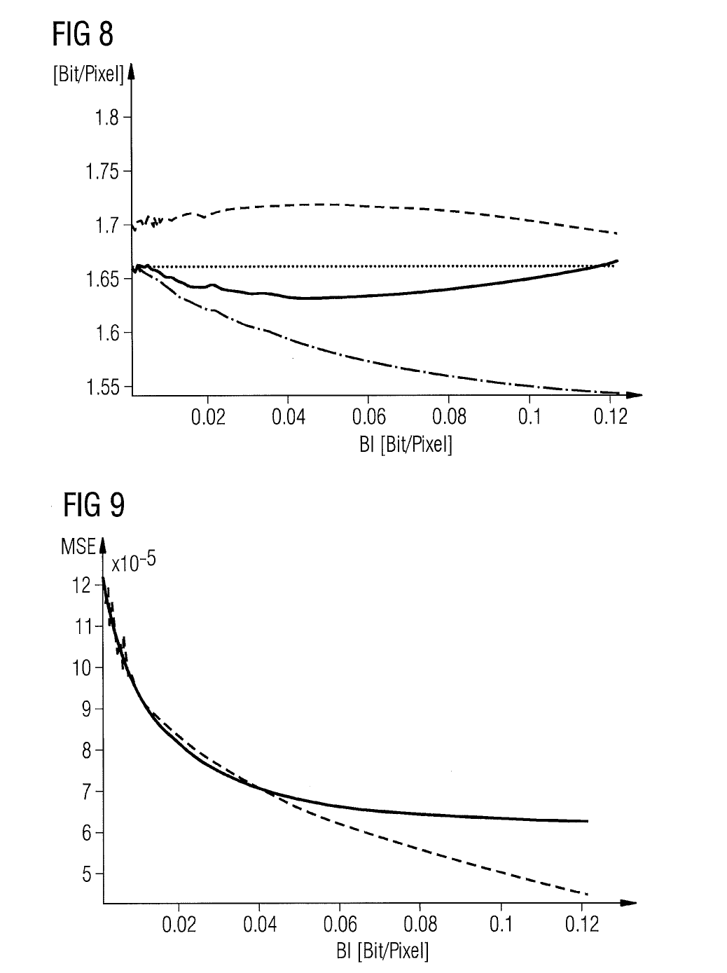

FIG. 8 shows how the mean residual error data quantity (in bits/pixels) changes according to a temporal and spatial prediction with an increasing motion information quantity BI (in bits/pixels). The motion information quantity BI here is the quantity of data for the motion information that is to be transmitted during the method, i.e. the motion vectors or motion vector components and their positions. A curve (broken line) for a block-based schematic diagram and a curve (dash-dot line) for the method are shown. The unbroken-line curve additionally shows the total information quantity (in bits/pixels) including the motion information quantity and the residual error information quantity using the method, wherein a relatively simple compression method was used for the residual error coding. For comparison purposes, the total information quantity (in bits/pixels) is also shown for a method in which the preceding image was used for prediction directly without motion estimation (dotted curve). In principle, a block-based schematic diagram is evidently even less favorable than such a method, in which the prediction is based directly on a preceding image. By contrast, the quantity of residual error information decreases by virtue of the method when additional motion vector information is added. When using the method, the minimum total information is achieved in the context of approximately 1 to 2 kB of motion information quantity per image. In the case of the image in FIGS. 10 and 11, for example, this minimum is achieved with 1170 motion vector components, which are illustrated in FIG. 12. The exact position of the minimum depends on the actual motion. The relatively poor performance of a block-based method is primarily due to the block artifacts in this context. A block-based method only works better for very large quantities of motion information, i.e. in the case of small block sizes. However, the total information quantity is then also significantly higher than in the method.

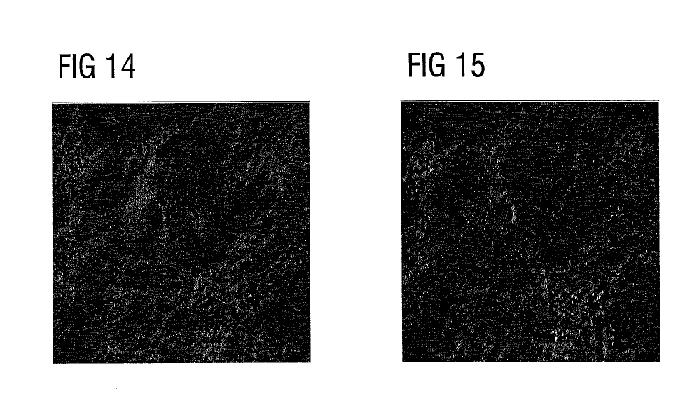

FIG. 14 shows a residual error image which was generated using the proposed method in accordance with the FIGS. 10 to 13. By comparison, FIG. 15 shows the corresponding residual error image as generated using a block-based method. The exact comparison of these images shows that no block artifacts occur in the method and therefore a smaller residual error is produced, particularly in regions featuring high intensity variations and flexible motion.

For the purpose of comparison, FIG. 9 again shows how the residual error quantity here in the form of the mean squared error MSE changes with the motion information quantity BI (in bits/pixels) when using the method (unbroken-line curve) and when using a block-based method (broken-line curve). The residual errors are approximately equal until a mean motion information quantity is reached, and only given high levels of motion vector information does the block-based method result in fewer residual errors, this explaining the rise of the unbroken-line curve in FIG. 8.

It is therefore evident that the above described variants of the proposed method, in which only motion vector components of relevant feature points are transmitted or stored and said relevant feature points depend on a predefined measure of confidence, result in only very little supplementary information in comparison with other methods. All in all, use of such a method therefore allows greater reductions in the data quantity, even in the case of lossless compression. In contrast with block-based methods, block artifacts in the context of lossy methods are essentially avoided.

Described below are two further coding methods 300, 500, in which the confidence vector field can be used in accordance with the proposals to determine motion vector field reconstruction parameters. Both methods are based on coefficients being determined by the coder with reference to the confidence vector field in order to reconstruct the motion vector field by linear superimposition of base functions.

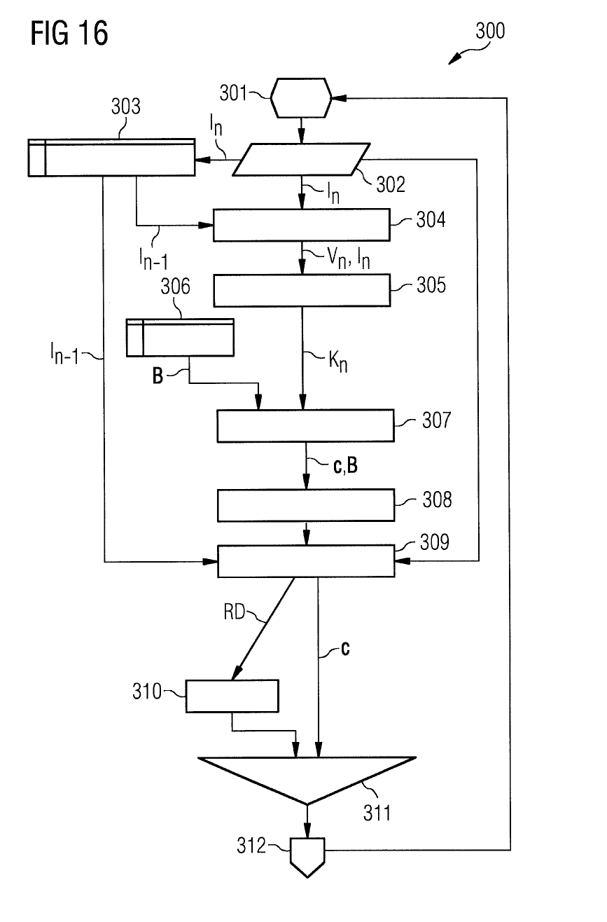

A flow diagram for a simple variant of such a method 300 is shown in FIG. 16. Once again, the processing of just one image Iₙ in the image sequence is illustrated here, it being assumed that a preceding image has already been stored and can be used in the context of the image coding.

The method starts at the step 301, provision being made again for reading in the raw data image Iₙ first in the step 302, such that it can be both stored in the step 303 for the coding of the next image and also used to generate a dense motion vector field Vₙ for the current image Iₙ in the step 304. The confidence vector field Kₙ is then determined in the step 305 on the basis of the dense motion vector field Vₙ and the current image Iₙ. The steps 304 and 305 do not differ from the steps 104, 105 in the method according to FIG. 2, and reference can therefore be made to the explanations concerning this.

The appropriate coefficients are now specified in the step 307, however, in order to represent the dense motion vector field by a linear combination of predefined base functions which are retrieved from storage in the step 306. This achieved by minimizing the target function

∥K*(B*c−v)∥ (4)

according to c. In this context, v is a vector containing all of the vector components of the current dense motion vector field Vₙ in a series, i.e. if the image contains q=M·N individual pixels, v has the length q and the individual vector elements correspond to the consecutively written components of the dense motion vector field. If an image of 512×512 pixels is processed, the vector v therefore has 512×512=262,144 elements in total. In this case, only one component is considered here first, e.g. only the x-component, as the processing also takes place componentially in this second embodiment of the method. This means that the coefficients for the x-component and y-component are determined separately, and therefore the optimization as per equation (4) is also executed separately for these components accordingly. Alternatively, provision can also be made for using a single overall vector v featuring twice the number of components, for example, or a separation can be effected according to angle and vector length, for example, etc. In this context, c is a vector comprising the desired coefficients (therefore c is also used generically in the following to designate the coefficients as a whole). If p base functions are to be used, the vector c has p elements accordingly. Possible examples of the number of base functions are p=256, p=1024 or p=10000. However, any other desired values can also be selected.

B is a q×p base function matrix which contains the predefined base functions b₁, . . . , bₚ in its columns, i.e. B=(b₁, b₂, b₃, . . . ) (therefore B is also used generically in the following to designate the base functions as a whole). The confidence values or the confidence vector field Kₙ for the current image is easily taken into consideration in equation (4) as a type of weighting function K, using a q×q matrix featuring the weighting values on the diagonal and zeros in the rest of the matrix in this case.

By virtue of the weighted linear regression according to equation (4), motion vectors having high confidence values are better approximated than vectors having low confidence values. This means that significantly better coefficients are automatically determined for reconstruction of the dense motion vector field than would be the case if the confidence values were not taken into consideration.

Once the coefficients c have been specified, a linear vector field reconstruction is performed in the step 308 on the basis of the predefined base functions B and the coefficients c that were specified previously in the step 307. On the basis of the dense motion vector field which has been reconstructed thus and the preceding image, a prediction image is then generated in the step 309 and subtracted from the current image, thereby determining the residual error data. This is coded in an intra-coding method in the step 310. The coefficients c are then also supplied to the entropy coding unit as motion vector field reconstruction parameters in the step 311 and linked to the intra-coded residual error data RD, such that they can then be sent or stored in the step 312. The coding of the next image in the image sequence then starts in the step 301.

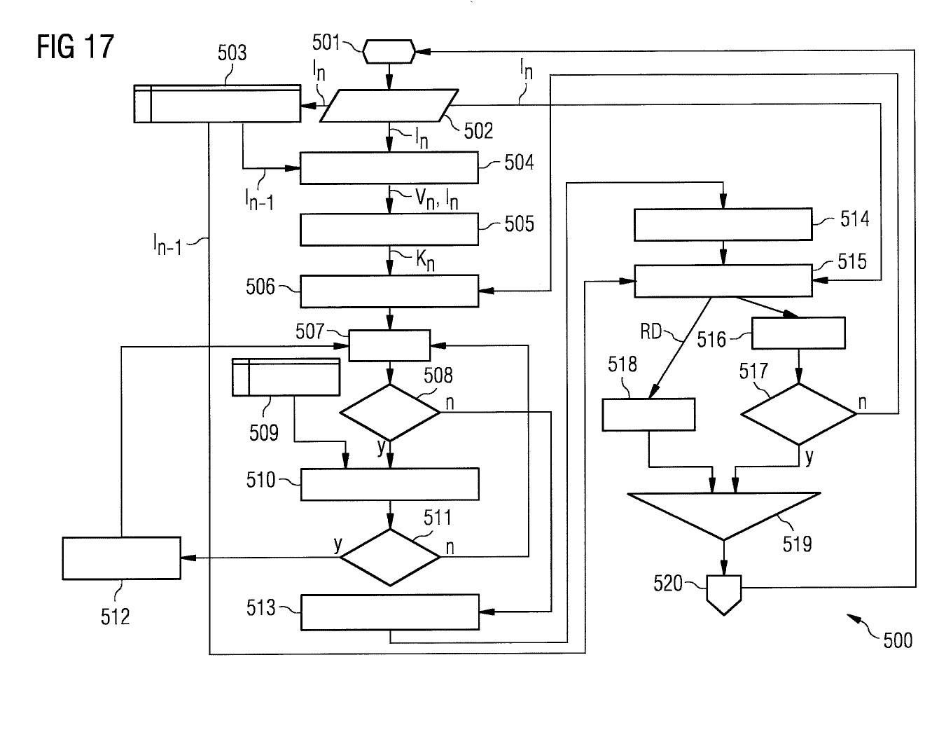

The coding method 300 according to FIG. 16 assumes that an ideal minimal set of base functions b₁, b₂, b₃, . . . is selected beforehand and is known to the decoder. FIG. 17 shows a somewhat modified coding method 500 as an alternative.

The steps 501, 502, 503, 504 and 505 correspond exactly to the steps 301 to 305 in the method according to FIG. 16, i.e. a RAW image Iₙ is read and stored for the purpose of coding the next image Iₙ while a dense motion vector field Vₙ is at the same time determined on the basis of the current image Iₙ and a confidence vector field Kₙ is then determined on the basis of these.

In contrast with the coding method 300 according to FIG. 16, however, not only the coefficients or the coefficient vector c but also the optimal base functions b₁, . . . , bₚ or base function matrix B are determined on the basis of the dense motion vector field Vₙ and the confidence vector field Kₙ in the coding method 500 according to FIG. 17.

This is achieved in the context of multiple executions of the loop via the steps 506 to 517, a “best” base function and an associated coefficient being determined in each execution of the loop. Within each execution of the loop, provision is made for performing multiple executions of an inner loop comprising the steps 507 to 512, in order to select the “best” base function (and the associated coefficients) from a larger group of possible predefined base functions.

For this purpose, an index variable and a target value are initialized in the step 506, e.g. the index variable is set to 0 and the target value to infinity. An increment of the index variable (e.g. increasing it by a value of 1) takes place in the step 507 of the inner loop in each case. By querying the value of the index variable in the step 508, provision is made for checking whether all of the base functions of the larger group of possible base functions have been checked. For this purpose, it is possible simply to check whether the index variable is still less than the number of base functions available for selection. If so (branch “y”), an optimization similar to equation (4) is performed in the step 510, wherein the equation

∥K*(b*c−v)∥ (5)

is however minimized according to c here. The confidence values or the confidence vector field Kₙ for the current image are also taken into consideration in equation (5) by virtue of the matrix K. Unlike equation (4), however, b here is just a vector with a single base function b from the group of possible predefined base functions to be checked in the relevant execution of the loop 507 to 512. A base function from this larger group of base functions is selected in the step 509 for this purpose. This can take place in any order in principle, but it must be ensured that each of the base functions available for selection is only checked once during the multiple execution of the loop 507 to 512. Correspondingly and unlike equation (4), c here is not a vector with the desired coefficients, but merely a single coefficient that is suitable for the respective base functions b, i.e. a scalar.

Only in the first execution of the outer loop 506 to 517 does the vector v in equation (5) represent the current dense motion vector field Vₙ. In the subsequent executions of this outer loop, the vector v represents only a “residual motion vector field”, from which is subtracted the vector field that can be reconstructed using the base functions and coefficients already determined in the previous executions, meaning that the vector v is updated in the outer execution during each iteration as follows:

v:=v−b*c (6)

In order to find the optimal coefficient c for the base function b which is currently being checked, provision is made in the step 510 for minimizing the function according to the coefficient c as per equation (5). In the step 511, the function value obtained in this case is compared with the target value that was initialized in the step 506. If the function value is less than the target value (branch “y”), the target value is updated in the step 512, in which it is replaced by the function value. As a result of the initialization of the target value in the step 506, this always applies during the first execution of the inner loop. The base function b which is currently being checked and the associated optimized coefficient c are also stored as provisional optimal values in the step 512.

In the step 507, the index variable is incremented again and the inner loop executed again, wherein another of the base functions b is then selected in the step 509 and the optimal coefficient c for this is determined in the step 510 by minimizing the equation (5) using the new base function b. If it is then established by the subsequent query in the step 511 that the current function value is less than the updated target value (branch “y”), i.e. the current base function is “better” than a preceding “best” base function, the updating of the target value takes place again in the step 512, and the base function b currently being checked and the associated optimized coefficient c are stored as new provisional optimal values. Otherwise (branch “n”), a return to step 507 is effected immediately in order to increment the index variable and then test a new base function.

If it is established in the step 508, during one of the executions of the inner loop 507 to 512, that the index variable has reached the number of base functions available for selection, i.e. that all of the base functions have been tested, the inner loop is terminated (branch “n”).

In the step 513, the vector v is then updated as described above with reference to equation (6) using the “best” base function b previously found in the inner loop and the associated “best” coefficient c. The found base function b is also incorporated in a base function matrix B and the associated coefficient c in a coefficient vector c in this step, such that an optimal base function matrix B and an optimal coefficient vector c are ultimately produced as a result of the overall method, this being similar to the method according to FIG. 16 (though in that case only the coefficient vector c is sought and the base function matrix B is predefined).

In a similar manner to the step 308 as per FIG. 16, a linear vector field reconstruction is then performed in the step 514 on the basis of the already available base functions and coefficients. In the step 515, the thus reconstructed dense motion vector field and the preceding image are then used to generate a prediction image again, this being subtracted from the current image such that the residual error data is determined.

The mean squared error MSE is then calculated in the step 516 and a check in step 517 establishes whether this mean squared error MSE is less than a maximal permitted error MSE_{Max}. If this is not the case (branch “n”), a return to the step 506 is effected in order to look for a further optimal base function for the purpose of supplementing or completing the previous set of base functions B, i.e. the base function matrix B, thereby further improving the reconstruction of the dense motion vector field. The index variable and the target value are then initialized again first, and the inner loop 507 to 512 is executed again for all of the base functions available for selection.

If it is established in the step 517 that the mean squared error MSE is less than the maximal permitted error MSE_{Max} (branch “y”), the method can be terminated as all optimal base functions B and their associated coefficients c have been found (B is also used generically in this method to designate the base functions as a whole, and c the associated coefficients irrespective of their representation as a matrix or vector). In an alternative termination variant, the method can also be terminated in the step 517 if a specific number of base functions is reached.

The intra-coding of the residual error data RD in the step 518, the entropy coding of the coefficients c and base functions B as motion vector field reconstruction parameters, the linking with the coded residual error data (e.g. using a multiplexing method) in the step 519, and the subsequent sending or storage in the step 520 again correspond to the procedure in the steps 310, 311 and 312 as per FIG. 16. In order to economize storage and/or transmission capacity, only limited information is actually transmitted, i.e. just enough to identify the base function B at the decoder, e.g. an index number of a large selection of base functions that are known to the decoder, or similar. It might also be possible to code the base functions as analytical functions (e.g. cos(10·x+3·y)). Any coding or transmission and/or storage of the base functions B is generally understood in the following to signify such an information transmission in reduced form.

It is noted here for the sake of completeness that, as in the other methods 100, 300, the coefficients and base functions in the coding method 500 according to FIG. 17 are determined separately for the x-direction and y-direction in the form of components. This correspondingly applies to the decoding method that is used for this purpose and explained below.

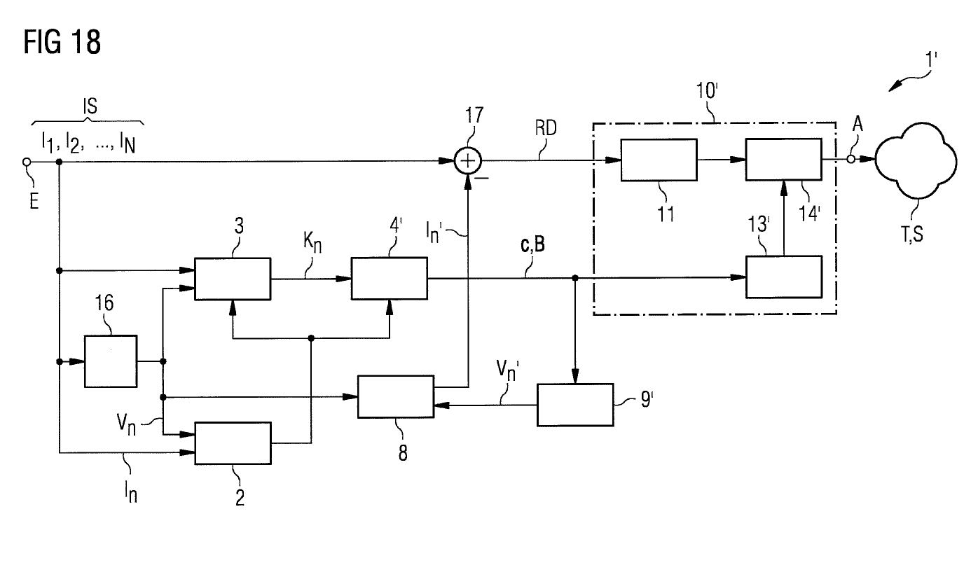

FIG. 18 shows a simplified block schematic diagram of an image coding device 1′ which can be used for performing a method as per the FIGS. 16 and 17. This image coding device 1′ is essentially very similar to the image coding device 1 in FIG. 5. Here likewise, the image sequence IS is received at an input E and a current image Iₙ is first stored in a buffer storage 16. In addition to this, a dense motion vector field Vₙ for the current image is generated in a motion vector field determination unit 2 and the confidence vector field Kₙ is determined in a confidence vector field determination unit 3.

However, the reconstruction parameter determination unit 4′ here includes a regression transformation unit which performs the step 302 in the case of the method 300 as per FIG. 16, and triggers or controls the steps 507 to 517 in the case of a method 500 as per FIG. 17.

In a similar manner to the exemplary embodiment according to FIG. 5, this device also features a motion vector field reconstruction unit 9′, which however here reconstructs the vector field by a linear combination of the predefined or likewise determined base functions B with the determined coefficients c, as explained above with reference to the steps 308 in the method 300 according to FIG. 16 or 514 in the method 500 according to FIG. 17.

A prediction image generation unit 8 is then used to generate the prediction image as per the steps 309 or 515 respectively. This prediction image is subtracted from the current image in the subtraction element 17 in order to obtain the residual error data RD.

Both the current coefficients c and optionally the base functions B that were determined in the method according to FIG. 17 are then passed with the residual error data RD to a coding unit 10′, from where the coded and linked data is supplied to a transmission channel T or stored in a storage S at the output A. The coding unit 10′ here includes an intra-coding unit 11 for coding the residual error data RD and an entropy coder 13′, which codes the coefficients c and optionally the associated base functions B. The coded data from the blocks 13′ and 11 is then linked together in a multiplexer 14′.

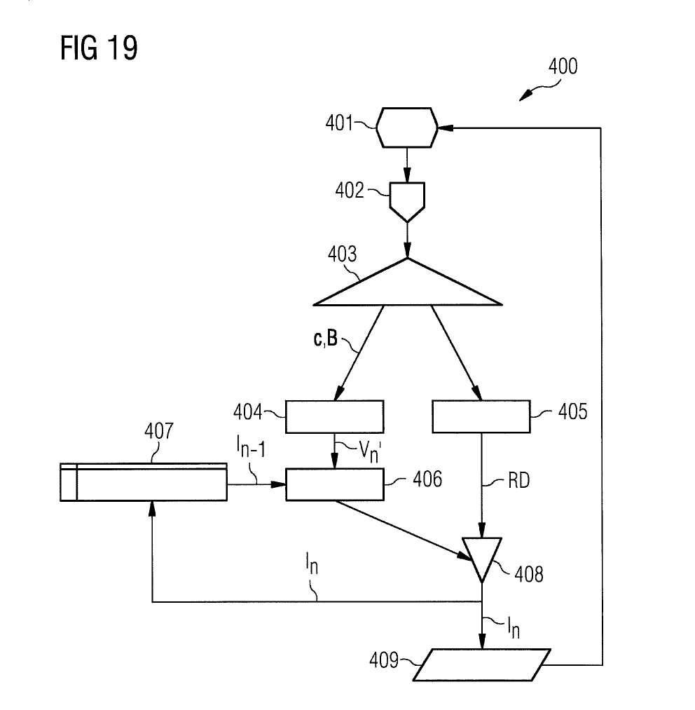

FIG. 19 shows how the image data that has been coded using the method 300 or 500 can be decoded again at the decoding unit. Here likewise, only the decoding of one image in the image sequence is represented, it being assumed that the data relating to a preceding image is already present. The decoding method 400 starts in the step 401, wherein the coded data is read in first in the step 402. Provision is then made in the step 403 for demultiplexing the data again and for entropy coding of the coefficients c and optionally the base functions B which are used for reconstruction of the motion vector field. In this step, the residual error data is separated out and supplied to an intra-decoding entity in the step 405. The information c, B for the motion vector field reconstruction is then used in the step 404 to reconstruct the motion vector field V′ₙ there by a linear combination of the base functions B with the predefined coefficients c. The motion vector field V′ₙ is then used in the step 406 to generate a prediction image on the basis of the image Iₙ₋₁ that was stored in the previous execution (step 407). This is then linked to the decoded residual error data RD in the step 408, such that in the step 409 the finished current raw data image Iₙ can be output or used subsequently.

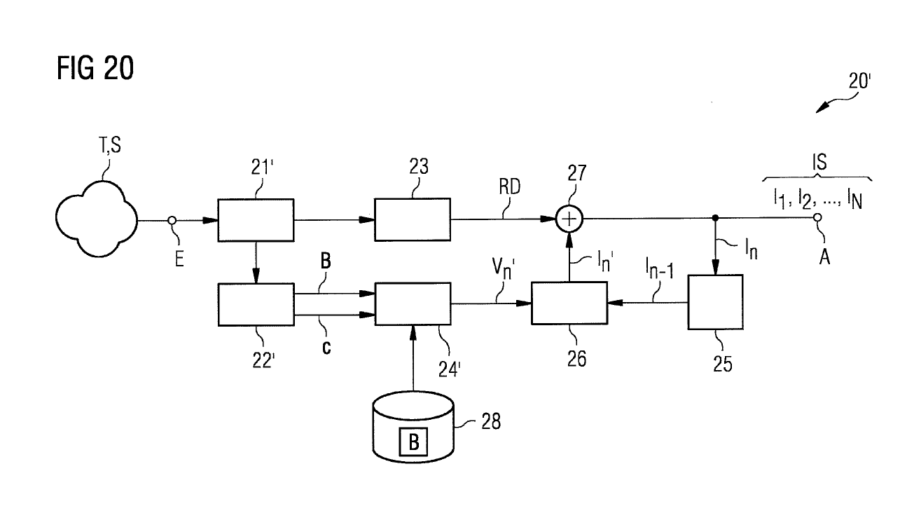

FIG. 20 shows a simplified block diagram of the decoding device 20′, whose structure is again very similar to that of the decoding device 20 according to FIG. 7. Here likewise, the coded data is received at the input E from a transmission channel T or a storage S. In a separation unit 21′, e.g. a demultiplexer, provision is first made for separating the coded residual error data and the coded motion vector field reconstruction parameters, here the coefficients c, and optionally the base functions B in the case of the method 500 according to FIG. 17. These coded motion vector field reconstruction parameters c, B are then decoded in a decoding unit 22′ and supplied to a motion vector field reconstruction unit 24′. If a coding method 300 as per FIG. 16 was used for the coding, only the coefficients c need be supplied here, and the motion vector field reconstruction unit 24′ takes the required predefined base functions B from a storage 28. If coding was performed by the coding method 500 as per FIG. 17, this storage 28 then holds e.g. the totality of all the base functions available for selection during the coding. The information which has been transmitted and is correspondingly supplied by the decoding unit 22′ for the purpose of identifying the selected base functions B, is then used to find these in the storage 28.

The dense motion vector field V′ₙ as reconstructed by the motion vector field reconstruction unit 24′ is then supplied to the prediction image generation unit 26, which generates a prediction image I′ₙ from the reconstructed motion vector field and a previously stored image Iₙ₋₁ that can be retrieved from a buffer storage 25. At the same time, the coded residual error data is decoded by an intra-decoder 23 and the residual error data RD is then superimposed with the prediction image I′ₙ in a summer 27, such that the complete decoded image Iₙ of the image sequence IS is finally provided. This can then be stored in the buffer storage 25 for the decoding of the next image, and output at the output A for subsequent use.

In conclusion, it is noted again that the detailed methods and designs described above are exemplary embodiments and that the fundamental principle can also be varied extensively by a person skilled in the art without thereby departing from the scope of the proposals. Although the proposals are described above with reference to images in the medical field, the proposals can also be advantageously applied to the coding of other image sequences, particularly if these primarily represent deformational motion. For the sake of completeness, it is also noted that the use of the indefinite article “a” or “an” does not does not preclude multiple occurrences of the features concerned. Likewise, the term “unit” does not preclude the relevant entity from being formed of a plurality of subcomponents, which can also be spatially distributed if applicable.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-16. (canceled)

17. A coding method to compress an image sequence, comprising:
determining a dense motion vector field for a current image region of the image sequence by comparing the current image region with at least one further image region of the image sequence;
determining a confidence vector field for the current image region, which confidence vector field specifies at least one confidence value for each motion vector of the motion vector field; and
determining motion vector field reconstruction parameters for the current image region based on the motion vector field and the confidence vector field.

18. The method as claimed in claim 17, wherein
a reconstructed motion vector field is formed by reconstruction using the motion vector field reconstruction parameters,
an image region prediction is determined for the current image region based on motion vectors of the reconstructed motion vector field,
residual error data of the image region prediction is determined with reference to the current image region, and
the motion vector field reconstruction parameters are linked to the residual error data of the current image region.

19. The method as claimed in claim 17, wherein the motion vector field and/or the confidence vector field are generated componentially in the form of vector component fields such that for an n-dimensional image, n vector component fields are separately generated.

20. The method as claimed in claim 17, wherein
relevant feature points of the motion vector field are determined for determining the motion vector field reconstruction parameters, and
the motion vector field reconstruction parameters each comprise location information of a relevant feature point and at least one motion vector component of a motion vector at a location of the relevant feature point.

21. The method as claimed in claim 20, wherein for determining the relevant feature points, candidate feature points are first determined based on the confidence vector field, and the relevant feature points are then selected from the candidate feature points.

22. The method as claimed in claim 21, wherein
a reconstructed motion vector field is formed by reconstruction using the motion vector field reconstruction parameters,
an image region prediction is determined for the current image region based on motion vectors of the reconstructed motion vector field, and
for selecting the relevant feature points from the candidate feature points:
for each candidate feature point, a reconstructed motion vector field and/or an image region prediction is generated for the current image region without a motion vector component belonging to the candidate feature point, and
each candidate feature point is evaluated regarding its effect on the reconstructed motion vector field and/or the image region prediction.

23. The method as claimed in claim 17, wherein coefficients are determined as motion vector field reconstruction parameters on the basis of the motion vector field and the confidence vector field, in order to form a reconstructed the motion vector field using predetermined base functions.

24. The method as claimed in claim 23, wherein
the coefficients are base function coefficients, and
base functions belonging to the base function coefficients are determined as motion vector field reconstruction parameters on the basis of the motion vector field and the confidence vector field, in order to form the reconstructed the motion vector field.

25. The method as claimed in claim 17, wherein
each position of the motion vector field has a motion vector and a predicted image point,
the predicted image point has its location based on the motion vector,
a deviation area is determined for each position of the motion vector field, which deviation area contains location deviations of the prediction image point from a corresponding image point in the current image region as a result of a change in the motion vector by a defined variation,
a curvature value is determined for each deviation area, the curvature value being in at least one direction,
the confidence vector field is comprised of confidence values for respective positions of the motion vector field, such that each curvature value has a corresponding confidence value, and
the confidence vector field is determined by using curvature values for corresponding confidence values.

26. The method as claimed in claim 17, wherein
the confidence vector field is used to eliminate unnecessary data in the dense motion vector field before transmission or storage.

27. A decoding method for decoding an image sequence which was coded using a coding method comprising determining a dense motion vector field for a current image region of the image sequence by comparing the current image region with at least one further image region of the image sequence; determining a confidence vector field for the current image region, which confidence vector field specifies at least one confidence value for each motion vector of the motion vector field; and determining motion vector field reconstruction parameters for the current image region based on the motion vector field and the confidence vector field, the decoding method comprising:
forming a reconstructed motion vector field for the current image region by reconstruction using the motion vector field reconstruction parameters; and
determining an image region prediction based on the reconstructed motion vector field.

28. The method as claimed in claim 27, wherein
the motion vector field reconstruction parameters are determined from relevant feature points of the motion vector field,
the motion vector field reconstruction parameters each comprise location information and at least one motion vector component of a motion vector at a location of the relevant feature point,
the reconstruction motion vector field is comprised of reconstructed motion vectors, and
reconstructed motion vectors at image points other than relevant feature points, are interpolated or extrapolated based on motion vectors at locations of the relevant feature points.

29. The method as claimed in claim 27, wherein
the image sequence is comprised of image regions,
the motion vector field reconstruction parameters are obtained after transmission and/or after retrieval from storage, and
the image regions of the image sequence are decoded using the motion vector field reconstruction parameters.

30. The method as claimed in claim 17, wherein
the image sequence is comprised of image regions,
the image regions of the image sequence are coded using the motion vector field reconstruction parameters and then transmitted or stored.

31. An article of manufacture, comprising:
an image coding device for compression of an image sequence, comprising:
a motion vector field determination unit to determine a dense motion vector field for a current image region of the image sequence by comparing the current image region with at least one further image region of the image sequence;
a confidence vector field determination unit to determine a confidence vector field for the current image region, which confidence vector field specifies at least one confidence value for each motion vector of the motion vector field; and
a reconstruction parameter determination unit to determine motion vector field reconstruction parameters for the current image region based on the motion vector field and the confidence vector field.

32. The article of manufacture as claimed in claim 31, further comprising:
an image decoding device comprising:
a motion vector field reconstruction unit to form a reconstructed motion vector field for the current image region by reconstruction using the motion vector field reconstruction parameters; and
a prediction image generation unit to determine an image region prediction based on the reconstructed motion vector field.

33. An image decoding device to decode image regions of an image sequence, which image regions were coded by a method comprising determining a dense motion vector field for a current image region of the image sequence by comparing the current image region with at least one further image region of the image sequence; determining a confidence vector field for the current image region, which confidence vector field specifies at least one confidence value for each motion vector of the motion vector field; and determining motion vector field reconstruction parameters for the current image region based on the motion vector field and the confidence vector field, the decoding device comprising:
a motion vector field reconstruction unit to form a reconstructed motion vector field for the current image region by reconstruction using the motion vector field reconstruction parameters; and
a prediction image generation unit to determine an image region prediction based on the reconstructed motion vector field.

34. A non-transitory computer readable storage medium storing a program, which when executed by an image processing computer, causes the image processing computer to perform a coding method to compress an image sequence, the coding method comprising:
determining a dense motion vector field for a current image region of the image sequence by comparing the current image region with at least one further image region of the image sequence;
determining a confidence vector field for the current image region, which confidence vector field specifies at least one confidence value for each motion vector of the motion vector field; and
determining motion vector field reconstruction parameters for the current image region based on the motion vector field and the confidence vector field.
